(19) United States
(12) Patent Application Publication
(10) Pub. No.: US 2024/0103542 A1
(43) Pub. Date: Mar. 28, 2024

(54) MOVING ROBOT AND CONTROLLING METHOD FOR THE SAME

(71) Applicant: LG ELECTRONICS INC, Seoul (KR)

(72) Inventors: Seungmin BAEK, Seoul (KR); Jeongwoo JU, Seoul (KR)

(21) Appl. No.: 17/768,558

(22) PCT Filed: Feb. 4, 2020
(86) PCT No.: PCT/KR2020/001616

§ 371 Date: Apr. 13, 2022

(30) Foreign Application Priority Data
Nov. 20, 2019 (KR) 10-2019-0149374

(51) Int. Cl. G05D 1/244; A01D 34/00; G05D 1/646

(52) U.S. Cl. CPC G05D 1/244; A01D 34/008; G05D 1/646; A01D 2101/00

(57) ABSTRACT

A moving robot and a controlling method for the same are disclosed, in which mapping is performed along a wire provided in a boundary of a task area. According to various embodiments disclosed in the present disclosure, since the moving robot self-drives along the wire when setting the task area, a user may acquire map information corresponding to the task area without directly manipulating the moving robot.

### TECHNICAL FIELD

Technical spirits disclosed in the present specification relate to a moving robot and a controlling method for the same, in which mapping is performed along a wire provided in a boundary of a task area.

### BACKGROUND ART

A robot has been developed for an industrial use and has been in charge of a portion of factory automation. Recently, an application field of the robot has been more enlarged and therefore a medical robot, a spacecraft robot, etc. have been developed and a robot for home use has been made. Among these robots, a robot that can selfdrive is referred to as a moving robot. A main example of a moving robot used in an outdoor environment of home is a lawn mower robot.

A lawn mower is a device for trimming lawn which is planted on yards of homes, playgrounds, and/or the like. The lawn mower is categorized into a lawn mower for home use, and a lawn mower for a tractor used in wide playgrounds or wide farms.

The lawn mower for home use is categorized into a walk behind type, where a user mows lawn while dragging a lawn mower behind, and a hand type where a user directly carries a lawn mower by hand.

However, in these two types of lawn mowers, there is inconvenience in that a user should directly operate the lawn mower.

Particularly, in a busy daily life, it is difficult for a user to directly operate the lawn mower to mow lawn on the yard, and therefore, workers are mostly hired, resulting in employment costs.

Therefore, automatic robot-type lawn mowers for preventing the occurrence of such additional costs and reducing the user's labor have been developed. Various studies for controlling the moving performance of the automatic robot-type lawn mower to allow the automatic robot-type lawn mower to exist in a desired area have been carried out.

The automatic robot-type lawn mower needs to previously set a movable area of a moving robot unlike a self-driving moving robot of which movable area is limited indoors due to walls or furniture.

Particularly, a lawn mowing robot needs to limit a movable area to drive an area where the lawn is planted.

Generally, when an area for driving the lawn mowing robot is set, a user sets a boundary of a task area by installing a wire and an anchor and then sets a map corresponding to the task area where the lawn is plated, while moving the lawn mowing robot along the boundary of the task area.

The prior art (US Laid-Open Patent No. US 20180352735 published on Dec. 13, 2018) discloses that a user sets a map of an area where the lawn is planted, while pushing a push bar attached to a main body of a lawn mowing robot and provided with a pressure sensor.

According to the prior art, there is inconvenience in that a user should directly operate the lawn mower to set a task area where the lawn mowing robot is driving.

### DISCLOSURE OF INVENTION

### Technical Problem

Accordingly, various embodiments disclosed herein are intended to solve the aforementioned problems.

One of various objects of the present disclosure is intended to provide a moving robot and a controlling method for the same, in which the moving robot may acquire map information corresponding to a task area while self-driving along a boundary of the task area.

One of various objects of the present disclosure is intended to provide a moving robot and a controlling method for the same, in which the moving robot may set its position to acquire map information corresponding to a task area while self-driving to reach a wire or anchor for setting a boundary of the task area.

### Solution to Problem

To achieve the objects of the present disclosure, various embodiments provide a moving robot and a controlling method for the same, in which the moving robot recognizes a wire or anchor for setting a boundary of a task area and then moves through a shortest distance to the wire or anchor and at the same time drives along the wire to align a position of the wire and the moving robot for acquiring map information corresponding to the task area.

An exemplary embodiment of the present disclosure provides a moving robot and a controlling method for the same, in which the moving robot acquires map information corresponding to a task area by acquiring coordinate information of a wire while self-driving along the wire.

An exemplary embodiment of the present disclosure provides a moving robot and a controlling method for the same, in which a position of the moving robot and a wire may be aligned by checking whether an alignment position of the moving robot and the wire has been changed while the moving robot is self-driving along the wire.

An exemplary embodiment of the present disclosure provides a controlling method for a moving robot which is driving a task area set by a wire, the controlling method comprising determining a position of the wire by recognizing the wire; aligning a position of the moving robot based on the position of the wire; a first driving step of acquiring coordinate information of the wire while the moving robot is driving along the wire after aligning the position of the moving robot; and a mapping step of generating map information corresponding to the task area based on the coordinate information of the wire.

The first driving step includes determining whether an alignment position of the wire and the moving robot has been changed, and a driving direction of the moving robot may be determined in accordance with the alignment position of the wire and the moving robot.

The alignment step may be performed by recognizing the wire if the alignment position of the moving robot is changed, and the driving direction of the moving robot may be maintained if the alignment position of the moving robot is not changed.

The first driving step may further include a direction setting step of determining the driving direction of the moving robot if the alignment position of the moving robot is changed.

The direction setting step may determine whether the driving direction of the moving robot is able to be maintained along the wire.

The controlling method may further comprise determining a shortest distance between the moving robot and the wire after determining the position of the wire, and a second driving step in which the moving robot drives toward the wire along the shortest distance.

If the moving robot reaches the wire after determining whether the moving robot has reached the wire, the alignment step may be performed.

An exemplary embodiment of the present disclosure provides a moving robot comprising a body forming an external appearance; a driver including wheels provided and rotated at both sides of the body, and a motor providing a rotational force to the wheels; a first sensor sensing a wire installed along a boundary of a task area where the body drives; and a controller driving the body by controlling the drive, wherein the controller controls the driver to allow the body to drive along the wire, by using information sensed by the first senor.

The controller may control the driver to align a position of the body based on the wire.

The controller may control the driver by determining a driving direction of the body.

The controller may determine whether an alignment position of the wire and the moving robot has been changed, and if the alignment position is changed, may determine the driving direction of the body by controlling the driver to allow the moving robot to drive along the wire.

The controller may control the driver to allow the wire to be arranged between the wheels.

The controller may generate map information corresponding to the task area based on coordinate information of the wire.

The respective features of the aforementioned embodiments may complexly be embodied in the other embodiments unless the features are conflict with or exclusive from the other embodiments.

### Advantageous Effects of Invention

According to various embodiments disclosed in the present disclosure, a user may acquire map information corresponding to a task area where a moving robot is driving, without directly manipulating the moving robot when setting the task area.

The effects that can be achieved through the embodiments of the present disclosure are not limited to what has been particularly described hereinabove and other effects which are not described herein can be derived by those skilled in the art from the following detailed description.

### BRIEF DESCRIPTION OF DRAWINGS

FIG. 1 is a perspective view illustrating one embodiment of a moving robot disclosed in the present disclosure.

FIG. 2 is a bottom view of FIG. 1.

FIG. 3 illustrates an embodiment in which a moving robot disclosed in the present disclosure is driving along a wire.

FIG. 4 is a block view illustrating a control relation of a moving robot disclosed in the present disclosure.

FIG. 5 is a block view illustrating a controlling method for a moving robot disclosed in the present disclosure.

FIG. 6 is a block view illustrating a controlling method for a moving robot disclosed in the present disclosure.

FIG. 7 is a block view illustrating a controlling method for a moving robot disclosed in the present disclosure.

### MODE FOR THE INVENTION

Hereinafter, the embodiments of the present disclosure will be described with reference to the accompanying drawings. The following detailed description is provided to assistant full understanding of a method, apparatus and/or system disclosed in the present disclosure. However, this is only exemplary, and the present disclosure is not limited to the following description.

In describing the embodiments of the present disclosure, if detailed description of elements or functions known in respect of the present disclosure is not relevant to the subject matter of the present disclosure, the detailed description will be omitted. The terms which will be described later are selected from generally known and used terms considering their functions in the present disclosure, and may be modified depending on intention of a person skilled in the art, practices, or the like. Accordingly, the terms used herein should be understood not simply by the actual terms used but by the meaning lying within and the description disclosed herein. The terms used herein are intended to describe the embodiments of the present disclosure, and should not be restrictive. It is to be understood that the singular expression used in this specification includes the plural expression unless defined differently on the context. In this description, it is to be understood that the terms such as “include” and “has” are intended to designate that features, numbers, steps, operations, elements, parts, or their combination, which are disclosed in the specification, exist, and are intended not to previously exclude the presence or optional possibility of one or more other features, numbers, steps, operations, elements, parts, or their combinations.

Front, rear, left, right, upper, and down, which are mentioned hereinafter, are expressions to refer to a direction, and are defined as shown. However, these terms are intended to assist understanding of the present disclosure, and may be defined differently depending on their references.

Also, in describing elements of the embodiments of the present disclosure, the terms “first”, “second”, “A”, “B”, “(a)”, “(b)”, etc. may be used. These terms are intended to identify the corresponding elements from the other elements, and basis, order, or number of the corresponding elements are not limited by these terms.

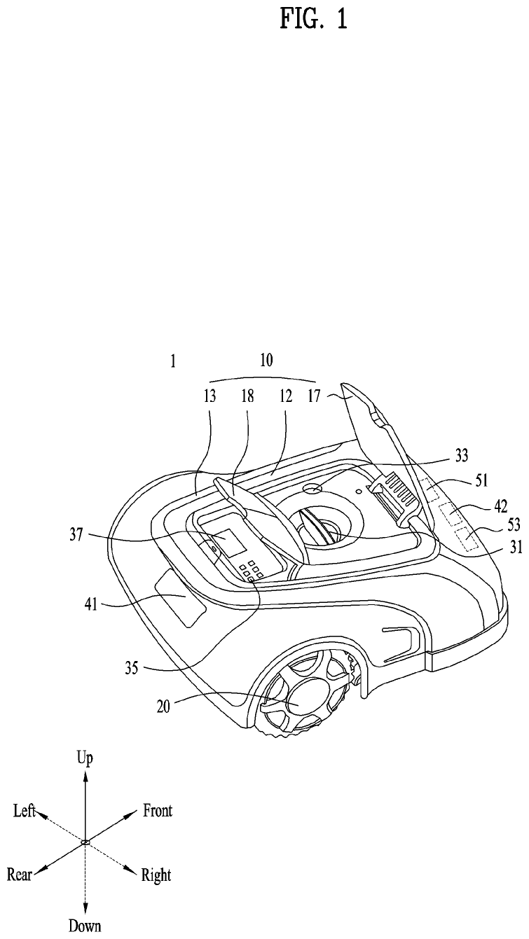

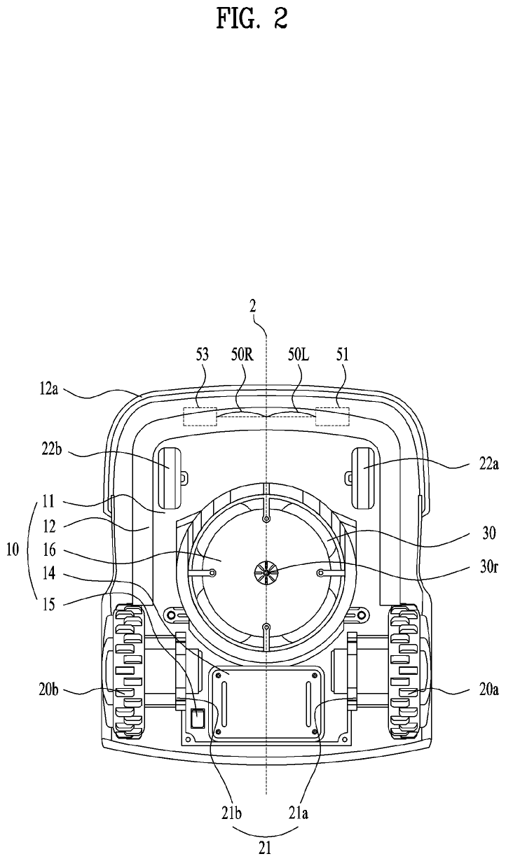

FIG. 1 is a perspective view illustrating one embodiment of a moving robot disclosed in the present disclosure, and FIG. 2 is a bottom view of FIG. 1.

Hereinafter, a description will be given with reference to FIGS. 1 and 2.

The moving robot 1 of this embodiment includes a body 10 forming an external appearance. The body 10 forms an inner space. The moving robot 1 includes a blade 30 mowing lawn while moving along a driving surface.

The body 10 includes a frame 11 forming a bottom of the moving robot 1, to which a wheel 20, a motor 21 and a blade 30 are fixed. A blade motor providing a rotational force to the blade 30 may be fixed to a rear surface of the frame 11. In addition, the frame 11 provides a frame structure supporting the other components. The frame 11 is supported on the driving surface by a side wheel 22 and the wheel 20.

A caster (not shown) rotatably supporting the side wheel 22 is arranged in the frame 11. The caster is arranged rotatably with respect to the frame 11. The caster is rotatably provided based on a vertical axis. The caster is arranged below the frame 11. A pair of casters corresponding to a pair of side wheels 22 are provided.

The body 10 includes a case 12 forming the inner space of the moving robot 1 by covering an upper portion of the frame 11. The case 12 forms an upper surface, a front surface, a rear surface, a left side and right side of the moving robot 12.

The body 10 may include a case connector (not shown) fixing the case 12 to the frame 11. The case 12 may be fixed to an upper end of the case connector. The case connector may movably be arranged in the frame 11. The case connector may movably be arranged up and down with respect to the frame 11. The case connector may movably be provided only within a predetermined range. As the case connector moves in a single body with the case 12, the case 12 is movable with respect to the frame 11.

The body 10 includes a bumper 12a arranged at the front. The bumper 12a is provided in front of the moving robot 1 to absorb impact when the moving robot 1 is in contact with an external obstacle in the middle of driving. The bumper 12a is formed such that a front surface and a left side are connected with each other to cover some of the front surface and the side of the body 10, and the front surface and the side of the bumper 12a are connected with each other to be rounded. Preferably, the bumper 12a is formed of a material favorable for absorbing impact.

The body 10 includes a handle 13. The handle 13 may be arranged at a rear side of the case 12. The handle 13 is configured to be grasped by a user, and may be arranged at a rear side of the case 12 to allow a user to more stably grasp the moving robot 1 because relatively weight elements such as the wheel 20, the motor 21 and a battery (not shown) are provided at the rear side of the moving robot 1.

The body 10 includes a battery cover 14 for taking out or inserting the battery (not shown) built in the moving robot 1. The battery cover 14 may be arranged at a lower side of the frame 11. The battery cover 14 may be arranged at a rear side of the frame 11.

The body 10 includes a power switch 15 for turning on/off a power source of the moving robot 1. The power switch 15 may be arranged in the frame 11.

The body 10 includes a blade cover 16 covering a lower side of a center portion of the blade 30. The blade cover 16 is provided to expose a centrifugal portion of the blade 30 but cover the center portion of the blade 30.

The blade 30 is rotated based on a rotary shaft 30r to mow lawn through a blade in a centrifugal portion. The blade cover 16 covers the center portion of the blade 30, thereby preventing a safety accident from occurring due to the blade 30 when the user handles the moving robot 1. Also, the blade cover 16 may prevent foreign materials such as lawn from being inserted into a rotational shaft portion of the blade 30 so as not to generate overload of a blade motor (not shown).

The body 10 includes a first cover 17 opening or closing a portion where a height control 311 and a height display 33 are arranged. The first cover 17 is rotatably hinge-coupled to the case 12 to enable an opening operation and a closing operation. The first cover 17 is arranged on an upper side of the case 12. The first cover 17 is formed in a plate shape to cover an upper side of the height control 31 and the height display 33 in a closed state. The first cover 17 may be made of a transparent material that allows a user to check the height display 33 in a closed state.

The moving robot 1 may be provided to change a height of the blade 30 from the ground and therefore may change a lawn-mowing height while driving. The height control 31 is an element that enables a height change of the blade 30, and may be provided as a rotatable dial. The user may change the height of the blade 30 by opening the first cover 17 and rotating the height control 31.

The height display 33 may display a height level of the blade 30. If the height of the blade 30 is changed by manipulation of the height control 31, a height level displayed by the height display 33 is changed correspondingly. For example, after the moving robot 1 performs lawn mowing at a current height of the blade 30, a height value of lawn may be predicted and displayed on the height display 33.

The body 10 includes a second cover 18 opening or closing a portion where a display module 37 and an input module 35 are arranged. The second cover 18 is rotatably hinge-coupled to the case 12 to enable an opening operation and a closing operation. The second cover 18 is arranged on an upper side of the case 12. The second cover 18 is arranged at the rear of the first cover 17. The second cover 18 is formed in a plate shape to cover the display module 37 and the input module 35 in a closed state. The second cover 18 may be made of a transparent material that allows a user to check the display module 37 in a closed state.

An opening angle of the second cover 18 is preferably set to be smaller than that of the first cover 17. This is because that the user may manipulate the height control 31 by easily opening the first cover 17 at an opening state of the second cover 18 and may visually and easily check a content of the height display 33 even in case of the opening state of the second cover 18.

Therefore, the first cover 17 is opened in such a manner that a rear end is lifted up based on a front end, and the second cover 18 is opened in such a manner that a rear end is lifted up based on a front end. The first cover 17 and the second cover 18 are preferably provided such that their opening operations do not interfere with each other.

The display module 37 is arranged at an upper side of the case 12 to output information to a user in an upper direction. For example, the display module 37 may include a thin film transistor liquid crystal display (LCD) panel. In addition, the display module 37 may be implemented using various display panels such as a plasma display panel or an organic light emitting diode display panel.

The input module 35 may include a button, a dial, a touch display, etc. Also, the input module 35 may include a mike (not shown) for voice recognition. The input module 35 of this embodiment may be provided as a plurality of buttons arranged at an upper side of the case 12.

The wheel 20 include a wheel 20a provided at a left side of the moving robot 1 and a wheel 20b provided at a right side of the moving robot 1. The pair of wheels are arranged to be spaced apart from each other in a horizontal direction, and are arranged below at a rear side of the body. Preferably, the pair of wheels are provided to be rotated independently. For example, when the pair of wheels are rotated at the same rotational speed, the body 11 may perform forward or backward movement with respect to the ground. If the rotational speed of the wheel 20a is different from that of the wheel 20b, the body 11 may perform rotational movement with respect to the ground.

That is, the wheel 20 is an element that directly affect driving of the moving robot 1.

The wheel 30 receives a power transferred from the motor 21. The motor 21 may be arranged in such a manner that a motor 21a providing a power to the wheel 20a and a motor 21b providing a power to the wheel 20b are spaced apart from each other at both sides. The motor 21 may be arranged at the rear below the body 11.

In this embodiment, the wheel 20a and the wheel 20b are directly connected to the rotational shaft of the motor 21a and the rotational shaft of the motor 21b. However, a component such as a shaft may be connected to the wheels, and the rotational force of the motor 21a or 21b may be transferred to the wheels 20a or 20b by a gear or chain.

The side wheel 22 is an element supporting the body 11 from the ground together with the wheel 20, and is arranged below at the front of the body 11. The side wheel 22 of this embodiment is arranged at the front of the blade 30. The side wheel 22 is a wheel to which a driving force of the motor is not transferred, and serves to subsidiarily support the body 11 with respect to the ground. The caster supporting the rotational shaft of the side wheel 22 is coupled to the frame 11 rotatably with respect to a vertical shaft. The side wheel 22 includes a side wheel 22a arranged at the left side and the side wheel 22b arranged at the right side.

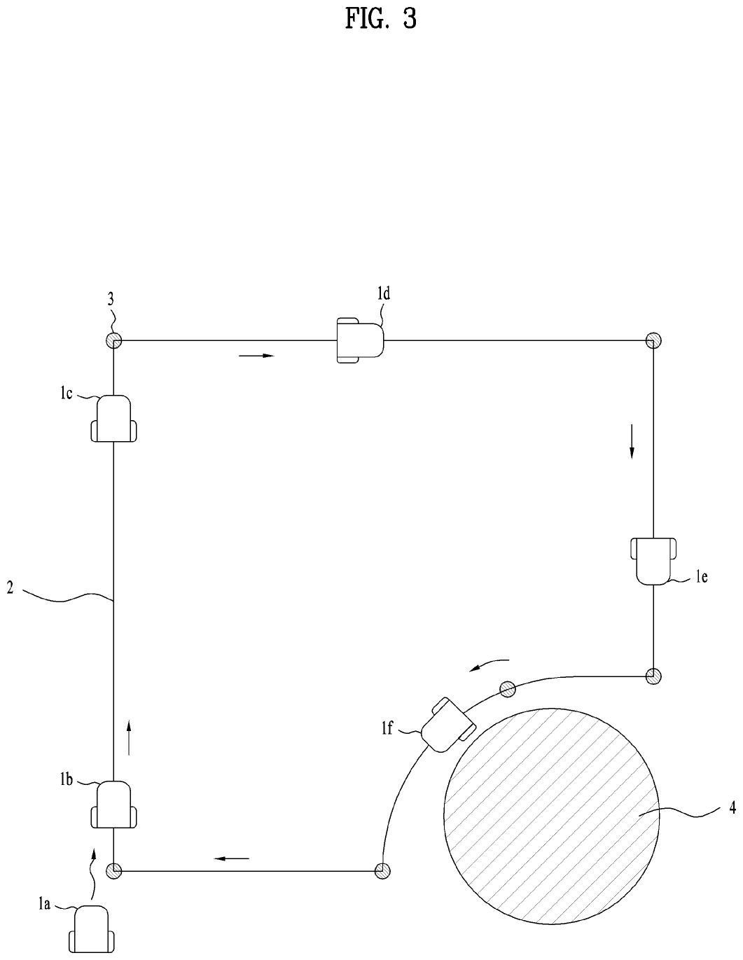

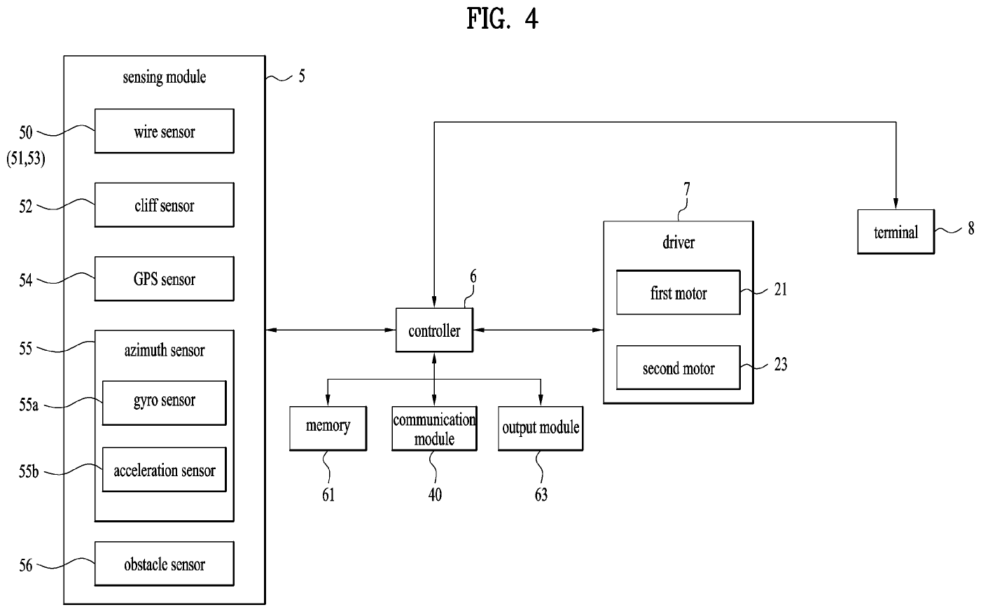

FIG. 3 illustrates an embodiment in which a moving robot disclosed in the present disclosure is driving along a wire, and FIG. 4 is a block view illustrating a control relation of a moving robot disclosed in the present disclosure.

Hereinafter, a description will be given with reference to FIGS. 1 to 4.

A front sensor 42 may be arranged at the front of the body 10, and a rear sensor 41 may be arranged at the rear of the body 10.

The front sensor 42 may be arranged at the front of the moving robot 1 to receive a remote signal transmitted from the front, and the rear sensor 41 may be arranged at the rear of the moving robot 1 to receive a remote signal transmitted from the rear.

The moving robot 1 may be provided with a communication module 40 that may perform communication with an external terminal 8, a server, a router, etc. The communication module 40 may be implemented to perform wireless communication between the moving robot 1 and the external terminal 8 by using wireless communication technologies such as UWB, Wi-Fi, Blue tooth, etc. The communication module 40 may be varied depending on a communication mode of another device or server which is desired to perform communication.

As a wireless short distance communication means, an ultra-wide-band (UWB) wireless digital pulse may be applied to this embodiment. The UWB module is advantageous as a relative distance measurement sensor of the moving robot 1 in view of speed, power consumption, distance measurement exactness, and a penetrating power. However, the communication means of this embodiment is not limited to the UWB module, and the aforementioned various wireless communication technologies may be used.

The front sensor 42 may be provided with an obstacle sensor 56 arranged at the front of the moving robot 1, which is a main driving direction, to sense obstacles. The obstacle sensor 56 senses obstacles located on a driving direction of the moving robot 1 or near the moving robot 1. The obstacle sensor 56 may include an infrared sensor, an ultrasonic sensor, an RF sensor, a geomagnetic sensor, a position sensitive device (PSD) sensor, etc.

The front sensor 42 may be provided with a cliff sensor 56 arranged at the front of the moving robot 1, which is a main driving direction, to sense a relative distance with a bottom surface. The cliff sensor 56 may sense a height of the moving robot with respect to the driving surface, or may sense the quantity of incident light reflected from the driving surface.

An azimuth sensor 55 may have a gyro sensing function. The azimuth sensor 55 may further have an acceleration sensing function. The azimuth sensor 55 may include a gyro sensor 55a and an acceleration sensor 55b for performing their respective functions.

The gyro sensor 55a may sense a horizontal rotation speed of the body 10. The gyro sensor 55a may sense an inclination speed for a horizontal surface of the body 10. The gyro sensor 55a may have a gyro sensing function for three orthogonal axes on a spatial coordinate system. Information collected from the gyro sensor 55a may be roll, pitch and yaw information. The gyro sensor 55a may calculate an azimuth angle of the moving robot 1 by integrating each azimuth speed.

The acceleration sensor 55b may have an acceleration sensing function for three orthogonal axes of the spatial coordinate system. A predetermined processing module may calculate a speed by integrating an acceleration and calculate a moving distance by integrating the speed.

The azimuth sensor 55 may sense a bottom surface having great difference in elevation existing on the driving surface of the moving robot 1 together with the cliff sensor 52.

The GPS sensor 52 may be provided to sense a global positioning system (GPS) signal. The GPS sensor 52 may be implemented using a PCB of a control part installed in the moving robot 1. The position of the moving robot 1 may be identified outdoor by the GPS sensor 52.

In addition to the sensors, the control part in which a plurality of components for driving control of the moving robot 1 and communication with an external module are included may be installed in the moving robot 1. The control part may be released after being installed during manufacture in accordance with performance of the moving robot 1 and category per product of the moving robot 1.

The wire sensor 50 and the front sensor 42 are arranged at the front of the body 10. The wire sensor 50 senses a wire 2 at the front which is a main driving direction of the moving robot 1 and includes a first sensor 51 and a second sensor 53 arranged to be spaced apart from each other at both sides to sense relative positions of the body 10 and the wire 2.

The first sensor 51 may be arranged at a left side in front of the body 10, and the second sensor 53 may be arranged at a right side in front of the body 10. The front sensor 42 may be arranged between the first sensor 51 and the second sensor 53.

The first sensor 51 may measure a relative distance for the left sides of the wire 2 and the body 10. The second sensor 53 may measure a relative distance for the right sides of the wire 2 and the body 10. Therefore, a relative position relation of the wire 2 and the body 10 may be identified by the first sensor 51 and the second sensor 53.

The moving robot 1 may drive while aligning the relative position with the wire 2 such that the controller 6 may control a driver 7 to position the wire 2 between the first sensor 51 and the second sensor 53.

The wire 2 is an element for setting a boundary of a task area of the moving robot 1, and the moving robot 1 may generate map information corresponding to the task area by using coordinate information of the wire 2 while driving along the wire 2.

Generation of the map information will be described in more detail. In a step of acquiring a map of an initial task area, a robot may acquire map information of the task area by arranging a UWB device, etc. in a roller (roller mapping) without directly driving, or may acquire map information of the task area while rotating the boundary of the task area by allowing a user to grip an anchor (anchor mapping). That is, various methods may be used in the step of generating and acquiring a map of the initial task area.

However, in case of roller mapping, a problem may occur in that mass information acquired by the UWB device should be transmitted to the robot, and a problem may also occur in that a position error may occur due to anchor signal interference caused by a person.

In case of anchor mapping, since all of anchors should be set and map information may be acquired, additional anchor may be required depending on an external condition, and a position error may occur due to anchor signal interference caused by a person.

Therefore, the moving robot 1 of this embodiment may acquire exact map information more easily by autonomously driving along the wire 2 for setting the boundary of the task area.

Since the moving robot 1 of this embodiment drives outdoor, it is required to previously set the boundary of the task area. This is because that the moving robot 1 of this embodiment should set the boundary of the task area outdoors unlike the case that the boundary of the task area is set by a wall, furniture, etc. in case of the moving robot which moves indoors.

The wire 2 and the anchor 3 set an area where lawn is mown by the moving robot 1 in accordance with driving of the moving robot 1, that is, the boundary of the task area. The anchor 3 may be inserted into one point of an edge of the task area by a user and the wire 2 may be installed along the anchor 3. The anchor 3 and the wire 2 between the anchors may be fixed to the bottom surface by a member such as peg without being buried in the bottom surface. Since the wire 2 sets the boundary of the task area, the wire 2 may be installed considering the obstacle 4 existing outdoors.

The controller 6 may control the driver 7 such that the wire 2 may be arranged at a place spaced apart from the first sensor 51 at a predetermined distance 50L, thereby preventing the wire 2 from being caught in the blade 30, the wheel 20, etc. while the moving robot 1 is driving. The controller 6 may control the driver 7 such that the wire 2 may be arranged at a place spaced apart from the second sensor 52 at a predetermined distance 50R.

Preferably, the distance 50L between the wire 2 and the first sensor 51 and the distance 50R between the wire 2 and the second sensor 53 are equal to each other. Therefore, the wire 2 may pass through the rotary shaft 30r of the blade 30, and may be arranged at the center of a wheel 20a and a wheel 20b.

The moving robot 1 may be arranged at any one point 1a of the outdoor. The point 1a means the outside of the boundary of the task area partitioned by the wire 2, and the moving robot 1 may move from the point 1a to the boundary of the task area. Therefore, the moving robot 1 may reach an initial set position 1b for acquiring the map information corresponding to the task area.

After or at the same time when the moving robot 1 reaches the initial set position 1b for acquiring the map information, the position of the moving robot 1 may be aligned based on the position of the wire 2. Position alignment of the moving robot 1 means that the wire 2 is arranged between the first sensor 51 and the second sensor 53 as described above. Preferably, the wire 2 is arranged at the center between the wheel 20a and the wheel 20b to pass through the rotary shaft 30r of the blade 30.

Hereinafter, the alignment position of the moving robot 1 and the wire 2 means that the wire 2 is arranged between the first sensor 51 and the second sensor 53.

The moving robot 1 drives along the wire 2 from the initial set position 1b. The wire 2 may be arranged to connect the anchor 3 with the anchor 3. Therefore, the wire 2 may be arranged to be curved based on the anchor 3. That is, the task area may be formed to be curved by the obstacle 4 existing outdoors. The wire 2 and the anchor 4 may be installed to avoid the obstacle 4, whereby the task area may be formed with a curved portion.

The relative position of the moving robot 1 and the wire 2 may be changed as the moving robot 1 passes through portions ic, le and if where the wire 2 is arranged to be curved. If the alignment position of the wire 2 and the moving robot 1 is changed by the wire sensor 50 arranged at the front of the moving robot 1, the controller 6 may control the driver 7 to change the driving direction of the moving robot 1.

If the alignment position of the wire 2 and the moving robot 1 is not changed, the controller 6 may determine to maintain the driving direction of the moving robot 1 by controlling the driver 7. That is, the wire 2 is continuously sensed by the wire sensor 50 while the moving robot 1 is driving, and as the controller 6 controls the driver 7 in accordance with updated information, the moving robot 1 drives along the wire 2.

The alignment position of the moving robot 1 and the wire 2 may be changed (ld) while the moving robot 1 climbs obstacles.

For example, branches of tree, stone, etc. existing on the ground outdoors are obstacles that may be climbed by the moving robot 1, and the moving robot 1 may determine to climb the obstacles in accordance with information acquired by the obstacle sensor 56. When the moving robot 1 climbs the obstacles, the alignment position of the moving robot 1 and the wire 2 may be changed. If the alignment position of the moving robot 1 and the wire 2 is changed, the wire 2 may be recognized through the wire sensor 50, and the controller 6 may align the positions of the moving robot 1 and the wire 2 such that the wire 2 may be provided in a right position by controlling the driver 7.

In this case, unlike the case that the driving direction of the moving robot 1 is changed as the moving robot 1 passes through the portions ic, le and if where the wire 2 is arranged to be curved, the driving direction is maintained, and the alignment position with the wire 2, which is changed by climbing of the moving robot 1 for the obstacles, is corrected.

Information collected by movement of the moving robot 1 along the wire 2 is stored in a memory 61, whereby the map information corresponding to the task area may be acquired by the controller 6. Also, the memory 61 may store preset programming information as well as information on an external condition, whereby the moving robot 1 may perform various modes by a user's manipulation.

An output module 63 may display various kinds of information of the moving robot 1 on the display module 37, whereby the user may identify the various kinds of information outside the moving robot 1. For example, a driving time of the moving robot 1, a driving distance of the moving robot 1, a remaining battery, a driving mode of the moving robot, etc. may be displayed on the display module 37.

The output module 63 may display a height level of the blade 30 on the height display 33. If the height of the blade 30 is changed in accordance with manipulation of the height control 31, the height level displayed by the height display 33 may be changed correspondingly.

The driver 7 may include a first motor 21 transferring a power to the wheel 20 for driving of the moving robot 1, and a second motor 23 transferring a power to the blade 30. Preferably, the first motor 21 and the second motor 23 are independently controlled. For example, when the moving robot 1 of this embodiment drives the task area along the wire 2, the power from the first motor 21 is required but the power from the second motor 23 is not required. If the blade 30 is rotated by the second motor 23, the wire 2 may be cut or damaged by the blade 30.

Since the moving robot 1 of this embodiment is controlled such that the wire 2 is arranged in the rotary shaft 30r of the blade 30, and drives along the wire 2, the wire 2 may be prevented from being damaged by the blade 30. However, if the alignment position between the moving robot 1 and the wire 2 is changed, the wire 2 or the blade 30 may be damaged. Therefore, when the moving robot 1 maps the task area along the wire 2, it is preferable that the second motor 23 is not driven.

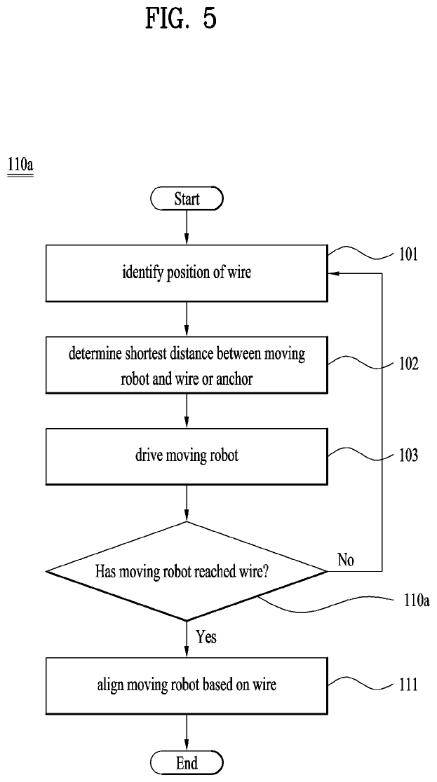

FIG. 5 is a block view illustrating a controlling method for a moving robot disclosed in the present disclosure.

Hereinafter, a description will be given with reference to FIGS. 1 to 5.

The controlling method 100a of this embodiment illustrates a moving flow to the boundary of the task area when the moving robot 1 is arranged at any one point 1a outdoors. The one point 1a means any one point of the area outside the task area.

The moving robot 1 identifies the position of the wire 2 (101). The identification of the position of the wire may be performed by determining the relative position of the moving robot 1 and the wire 2, or may be performed by determining a position of a virtual line crossing the anchors 3 after determining the position of the anchor 3.

After the position of the wire 2 is identified (101), the moving robot 1 determines a shortest distance to the wire 2 or the anchor 3 (102). The determination of the shortest distance may be performed by determining the shortest distance from the moving robot 1 to the recognized wire 2 by using various distance sensors, or may be performed by determining the shortest distance from the moving robot 1 to the recognized anchor 3.

The moving robot 1 performs a second driving step 103 along the shortest distance after determining the shortest distance to the wire 2 or the anchor 3 (102).

After the moving robot 1 drives along the shortest distance (103), the moving robot 1 determines whether it has reached the wire 2 (110a). The moving robot 1 moves along the shortest distance to the anchor 3 or the wire 2. This is because that the case that the moving robot 1 reaches the boundary of the task area through the shortest distance to the wire 2 and the case that the moving robot 1 reaches the boundary of the task area through the shortest distance to the anchor 3 should be considered.

Whether the moving robot 1 has reached the wire 2 (110a) may be determined by preset various references. For example, if the wire 2 reaches a radius sensed by the wire sensor 50 based on whether the wire 2 is arranged within the radius, it may be determined that the moving robot 1 has reached the wire 2. That is, it is sufficient to determine that the moving robot 1 has reached the wire 2, and it is not required to necessarily align the moving robot 1 based on the wire 2.

If the moving robot 1 reaches the wire 2, an alignment step 111 is performed in such a manner that the moving robot 1 is aligned based on the wire 2. If the moving robot 1 does not reach the wire 2, the moving robot 1 repeatedly performs the step 101 of identifying the position of the wire 2.

The alignment step 111 means that the moving robot 1 is aligned based on the wire 2 such that the wire 2 is arranged between the first sensor 51 and the second sensor 53, as described above.

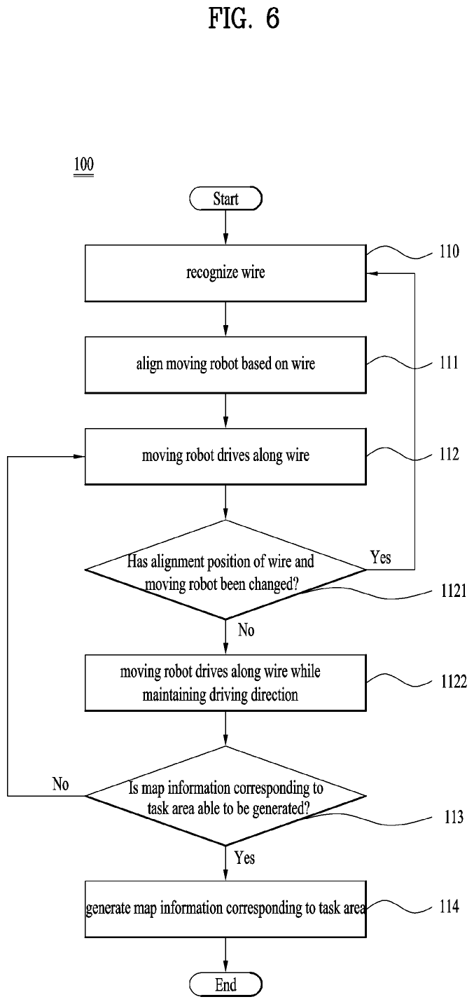

FIG. 6 is a block view illustrating a controlling method for a moving robot disclosed in the present disclosure. Hereinafter, a description will be given with reference to FIGS. 1 to 6.

The controlling method 100 of this embodiment illustrates a change flow of an alignment position of the moving robot 1 and the wire 2, which may occur when the moving robot climbs obstacles while driving along the wire 2 defining the boundary of the task area.

The controlling method 100 of this embodiment illustrates a flow of the moving robot 1 that acquires map information corresponding to the task area while driving a closed curve or closed loop, which is defined by the boundary of the task area, along the wire 2.

The moving robot 1 recognizes the position of the wire 2 through the wire sensor 50 (110).

After the moving robot 1 recognizes the position of the wire 2 (110), the alignment step 111 of aligning the position of the moving robot 1 based on the position of the wire 2 is performed. In the alignment step 111, the position of the moving robot 1 is aligned such that the wire 2 is arranged between the first sensor 51 and the second sensor 53. The position of the moving robot 1 is aligned such that the wire 2 is arranged at the center between the first sensor 51 and the second sensor 53. The position of the moving robot 1 is aligned such that the wire 2 is arranged between the respective wheels 20a and 20b provided at both sides of the moving robot 1. The position of the moving robot 1 is aligned such that the wire 2 is arranged at the center between the wheels 20a and 20b. The position of the moving robot 1 is aligned such that the wire 2 is arranged to cross the rotary shaft 30r of the blade 30. At least two of the positions where the wire 2 is aligned may mean the same position.

After the position of the wire 2 is identified through the wire sensor 50 in the alignment step 111, the controller 6 controls the position of the moving robot 1 by controlling the driver 7 based on position information of the wire 2.

After the alignment step 111, the first driving step 112 is performed, in which the moving robot 1 acquires coordinate information of the wire 2 while driving along the wire.

In the first driving step 112, in a state that the position of the moving robot 2 is aligned based on the wire 2, the moving robot drives the boundary of the task area along the wire 2. The moving robot 1 acquires map information of the task area of which boundary is defined by the wire 2, by acquiring the coordinate information of the wire 2.

Since the task area forms a closed curve or closed loop by the wire 2, the acquired coordinate information of the wire 2 may be stored in the memory 61 and used to acquire the map information of the task area by a predetermined processing module.

The acquired coordinate information of the wire 2 is transmitted to the external terminal 8 in real time, and the map information of the task area is generated through the external terminal 8. Then, the map information may be transmitted to the moving robot 1.

That is, this embodiment is not limited to the method for generating map information, and the map information corresponding to the task area may be acquired by various methods by using the information acquired by driving of the moving robot 1 along the wire 2.

Whether the alignment position of the moving robot 1 and the wire 2 has been changed in the middle of the first driving step 112 (1121). The step 1121 of determining whether the alignment position has been changed may be performed when a predetermined impact is given to the moving robot 1, or may be performed continuously while the moving robot 1 is driving.

If the alignment position of the wire 2 and the moving robot 1 is changed, the step 110 of recognizing the position of the wire 2 is performed. After the position of the wire 2 is determined, the aforementioned steps are repeatedly performed.

If the alignment position of the wire 2 and the moving robot 1 is not changed, the step 110 of recognizing the position of the wire 2 is performed. After the position of the wire 2 is determined, the aforementioned steps are repeatedly performed.

After driving along the wire 2, the moving robot 1 determines whether to be able to generate the map information corresponding to the task area (113).

As the moving robot 1 drives along the wire 2, if the map information corresponding to the task area is able to be generated, a mapping step 114 of generating the map information corresponding to the task area is performed. If the map information corresponding to the task area is not generated, the first driving step 112 is repeatedly performed, in which the moving robot 1 drives along the wire 2 while maintaining the alignment position.

Since the position of the moving robot 1 is aligned based on the wire 2 in the alignment step 111 of this embodiment, the driving direction of the moving robot 1 may be changed.

The controlling method 100 described in this drawing may be performed sequentially with the controlling method 100a described in FIG. 5. In the controlling method 100a, the step 111 of aligning the moving robot based on the wire may mean the alignment step 111 of the controlling method 100 described in this drawing.

The controlling method 100a described in FIG. 5 and the controlling method 100 described in this drawing may be set by an order relation on a temporal order. That is, in the controlling method 100a described in FIG. 5, after the moving robot 1 arranged outside the task area reaches the wire 2 to perform mapping of the task area, its position is aligned based on the wire 2. Therefore, after the position of the moving robot 1 is aligned based on the wire 2, the controlling method 100 described in this drawing may be performed.

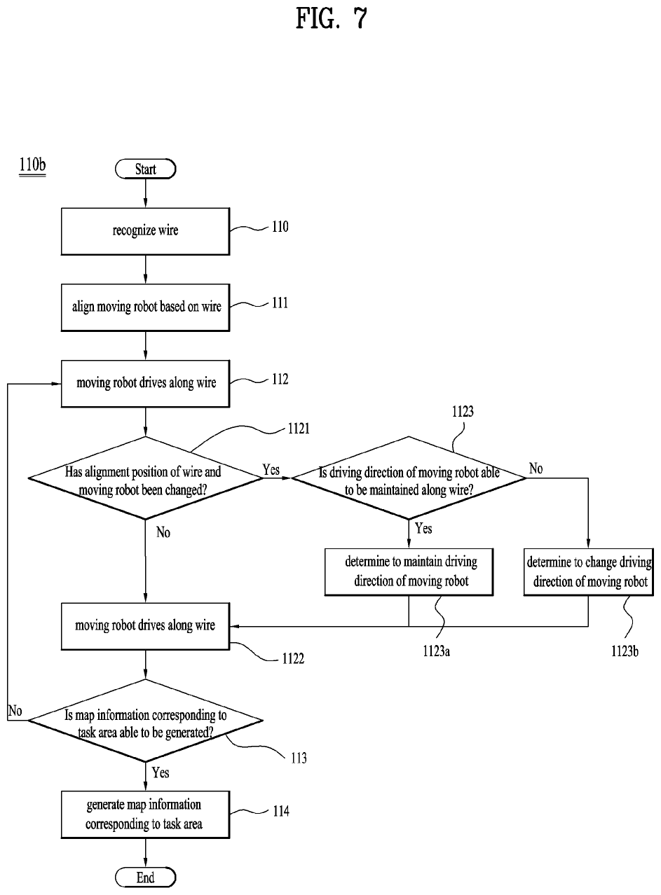

FIG. 7 is a block view illustrating a controlling method for a moving robot disclosed in the present disclosure. Hereinafter, a description will be given with reference to FIG. 7.

The controlling method 100b of this embodiment illustrates a flow of the moving robot 1 that acquires map information corresponding to the task area while driving a closed curve or closed loop, which is defined by the boundary of the task area, along the wire 2.

The controlling method 100b of this embodiment illustrates a change flow of an alignment position of the moving robot 1 and the wire 2, which may occur when the moving robot climbs obstacles while driving along the wire 2 defining the boundary of the task area.

The moving robot 1 recognizes the position of the wire 2 through the wire sensor 50 (110).

After the moving robot 1 recognizes the position of the wire 2 (110), the alignment step 111 of aligning the position of the moving robot 1 based on the position of the wire 2 is performed. In the alignment step 111, the position of the moving robot 1 is aligned such that the wire 2 is arranged between the first sensor 51 and the second sensor 53. The position of the moving robot 1 is aligned such that the wire 2 is arranged at the center between the first sensor 51 and the second sensor 53. The position of the moving robot 1 is aligned such that the wire 2 is arranged between the respective wheels 20a and 20b provided at both sides of the moving robot 1. The position of the moving robot 1 is aligned such that the wire 2 is arranged at the center between the wheels 20a and 20b. The position of the moving robot 1 is aligned such that the wire 2 is arranged to cross the rotary shaft 30r of the blade 30. At least two of the positions where the wire 2 is aligned may mean the same position.

After the position of the wire 2 is identified through the wire sensor 50 in the alignment step 111, the controller 6 controls the position of the moving robot 1 by controlling the driver 7 based on position information of the wire 2.

After the alignment step 111, the first driving step 112 is performed, in which the moving robot 1 acquires coordinate information of the wire 2 while driving along the wire.

In the first driving step 112, in a state that the position of the moving robot 2 is aligned based on the wire 2, the moving robot drives the boundary of the task area along the wire 2. The moving robot 1 acquires map information of the task area of which boundary is defined by the wire 2, by acquiring the coordinate information of the wire 2.

Since the task area forms a closed curve or closed loop by the wire 2, the acquired coordinate information of the wire 2 may be stored in the memory 61 and used to acquire the map information of the task area by a predetermined processing module.

The acquired coordinate information of the wire 2 is transmitted to the external terminal 8 in real time, and the map information of the task area is generated through the external terminal 8. Then, the map information may be transmitted to the moving robot 1.

That is, this embodiment is not limited to the method for generating map information, and the map information corresponding to the task area may be acquired by various methods by using the information acquired by driving of the moving robot 1 along the wire 2.

Whether the alignment position of the moving robot 1 and the wire 2 has been changed in the middle of the first driving step 112 (1121). The step 1121 of determining whether the alignment position has been changed may be performed when a predetermined impact is given to the moving robot 1, or may be performed continuously while the moving robot 1 is driving.

If the alignment position of the wire 2 and the moving robot 1 is changed, a direction setting step 1123 of determining whether the driving direction of the moving robot is able to be maintained along the wire 2 is performed.

The direction setting step 1123 is performed when the alignment position of the wire 2 and the moving robot 1 is changed while the moving robot 1 is driving along the wire 2. The case that the alignment position is changed may include the positions 1c, 1d, 1e and if marked in FIG. 3.

In detail, the direction setting step 1123 of the moving robot 1 may be performed when the wire 2 reaches curved portions based on the anchor 3 (1c, 1e and 1f). Since the moving robot 1 should drive along the wire 2, the driving direction of the moving robot 1 should be changed in the boundary of the task area curved as above.

Therefore, the moving robot 1 drives along the wire 2 (1122) by determining to change the driving direction in the boundary of the curved task area (1123b).

The alignment position of the moving robot 1 may be changed depending on an abnormal status such as climbing and trapping of obstacles. If the alignment position of the moving robot 1 and the wire 2 is changed, the direction setting step 1123 may be performed. Since the moving robot 1 should drive along the wire 2, if a position in front of the moving robot 1 is inclined toward one side based on the driving direction in the abnormal status as above, the front of the moving robot 1 should be matched with the driving direction.

Therefore, if the alignment position of the moving robot 1 is changed depending on the abnormal status such as climbing and trapping of obstacles, the moving robot 1 drives along the wire 2 (1122) by determining to maintain the existing driving direction (1123a).

If the alignment position of the moving robot 1 and the wire 2 is not changed, the moving robot 1 drives along the wire 2 (1122). The alignment position of the moving robot 1 and the wire 2 is maintained while the moving robot 1 is driving along the wire 2.

The moving robot 1 acquires coordinate information of the wire 2 while driving along the wire 2. Therefore, after driving along the wire 2 (1122), the moving robot 1 determines whether to be able to generate the map information corresponding to the task area (113).

As the moving robot 1 drives along the wire 2, if the map information corresponding to the task area is able to be generated, a mapping step 114 of generating the map information corresponding to the task area is performed. If the map information corresponding to the task area is not generated, the first driving step 112 is repeatedly performed, in which the moving robot 1 drives along the wire 2 while maintaining the alignment position.

The controlling method 100b described in this drawing may be performed sequentially with the controlling method 100a described in FIG. 5. In the controlling method 100a, the step 111 of aligning the moving robot based on the wire may mean the alignment step 111 of the controlling method 100 described in this drawing.

The controlling method 100a described in FIG. 5 and the controlling method 110b described in this drawing may be set by an order relation on a temporal order. That is, in the controlling method 100a described in FIG. 5, after the moving robot 1 arranged outside the task area reaches the wire 2 to perform mapping of the task area, its position is aligned based on the wire 2. Therefore, after the position of the moving robot 1 is aligned based on the wire 2, the controlling method 100 described in this drawing may be performed.

The controlling method 100 described in FIG. 6 and the controlling method 100b described in this drawing may be performed independently or in parallel.

The case that the moving robot 1 drives along the wire after determining whether the alignment position of the wire and the moving robot has been changed (1121) in FIG. 6 may correspond to the case that the moving robot 1 drives along the wire 2 after determining whether the alignment position of the wire and the moving robot has been changed (1121) in this drawing.

It will be apparent to those skilled in the art that the present disclosure may be embodied in other specific forms without departing from the spirit and essential characteristics of the disclosure. Thus, the above embodiments are to be considered in all respects as illustrative and not restrictive. The scope of the disclosure should be determined by reasonable interpretation of the appended claims and all change which comes within the equivalent scope of the disclosure are included in the scope of the disclosure.

1. A controlling method for a moving robot which is driving a task area set by a wire, the controlling method comprising:
determining a position of the wire by recognizing the wire;
aligning a position of the moving robot based on the position of the wire;
a first driving step of acquiring coordinate information of the wire while the moving robot is driving along the wire after aligning the position of the moving robot; and
a mapping step of generating map information corresponding to the task area based on the coordinate information of the wire.

2. The controlling method of claim 1, wherein the first driving step includes determining whether an alignment position of the wire and the moving robot has been changed; and determining a driving direction of the moving robot in accordance with the alignment position of the wire and the moving robot.

3. The controlling method of claim 2, wherein the alignment step is performed by recognizing the wire if the alignment position of the moving robot is changed.

4. The controlling method of claim 2, wherein the driving direction of the moving robot is maintained if the alignment position of the moving robot is not changed.

5. The controlling method of claim 2, wherein the first driving step further includes a direction setting step of determining the driving direction of the moving robot if the alignment position of the moving robot is changed.

6. The controlling method of claim 5, wherein the direction setting step determines whether the driving direction of the moving robot is able to be maintained along the wire.

7. The controlling method of claim 1, further comprising determining a shortest distance between the moving robot and the wire after determining the position of the wire.

8. The controlling method of claim 7, further comprising a second driving step in which the moving robot drives toward the wire along the shortest distance.

9. The controlling method of claim 8, wherein, if the moving robot reaches the wire after determining whether the moving robot has reached the wire, the alignment step is performed.

10. A moving robot comprising:
a body forming an external appearance;
a driver including wheels provided and rotated at both sides of the body, and a motor providing a rotational force to the wheels;
a first sensor sensing a wire installed along a boundary of a task area where the body drives; and
a controller driving the body by controlling the driver,
wherein the controller controls the driver to allow the body to drive along the wire, by using information sensed by the first senor.

11. The moving robot of claim 10, wherein the controller controls the driver to align a position of the body based on the wire.

12. The moving robot of claim 11, wherein the controller controls the driver by determining a driving direction of the body.

13. The moving robot of claim 12, wherein the controller determines whether an alignment position of the wire and the moving robot has been changed, and if the alignment position is changed, determines the driving direction of the body by controlling the driver to allow the moving robot to drive along the wire.

14. The moving robot of claim 11, wherein the controller controls the driver to allow the wire to be arranged between the wheels.

15. The moving robot of claim 10, wherein the controller generates map information corresponding to the task area based on coordinate information of the wire.
